(19) United States
(12) Patent Application Publication
(10) Pub. No.: US 2025/0075020 A1
(43) Pub. Date: Mar. 6, 2025

(54) WATER-RETAINING MATERIAL, WATER-RETAINING PROTON EXCHANGE MEMBRANE, PREPARATION METHOD AND APPLICATION THEREOF

(71) Applicant: Southern University of Science and Technology, Shenzhen, Guangdong (CN)

(72) Inventors: Jiexin ZOU, Shenzhen, Guangdong (CN); Min WANG, Shenzhen, Guangdong (CN); Haijiang WANG, Shenzhen, Guangdong (CN)

(73) Assignee: Southern University of Science and Technology, Shenzhen, Guangdong (CN)

(21) Appl. No.: 18/250,654

(22) PCT Filed: Dec. 30, 2022
(86) PCT No.: PCT/CN2022/144003

§ 371 Date: Apr. 26, 2023

(51) Int. Cl. C08F 251/00; B01D 69/12; C08J 5/22

(52) U.S. Cl. CPC C08F 251/00; B01D 69/1216; C08J 5/22; C08J 2305/00

(57) ABSTRACT

A water-retaining material, including: a polymer chain segment provided by a hydrophilic polymer; and a proton carrier group grafted to the polymer chain segment. The polymer chain segment contains a hydrophilic group. A method for preparing a water-retaining material, includes: performing, in a reaction system including an activator and a catalyst, a grafting reaction between a hydrophilic polymer and a proton carrier compound to yield the water-retaining material. The water-retaining material contains a polymer chain segment containing a hydrophilic group. A water-retaining proton exchange membrane, includes a matrix. The matrix is doped with a water-retaining material; and the water-retaining material including the above water-retaining material.

### CROSS-REFERENCE TO RELATED APPLICATIONS

This application is the U.S. national phase of International Application No. PCT/CN2022/144003 with an international filing date of Dec. 30, 2022, designating the U.S., now pending. The contents of all of the aforementioned applications, including any intervening amendments thereto, are incorporated herein by reference.

### TECHNICAL FIELD

The present application relates to the technical field of electrochemistry, and more particularly to a water-retaining material, a water-retaining proton exchange membrane, preparation method thereof and application thereof.

### BACKGROUND

As a necessary component in electrochemical fields, such as fuel cells, water electrolysis, and electrochemical hydrogen compression, a proton exchange membrane allows water molecules and protons (or hydrogen ions) to pass through, while isolating other particles. A common proton exchange membrane is made of a polyether ether ketone, a polybenzimidazol, a perfluorosulfonic acid resin, and the like.

Taking an electrochemical hydrogen compression as an example, a key component therein is the membrane electrode, which consists of a proton exchange membrane, a catalyst layer, and a gas diffusion layer. A principle of the electrochemical hydrogen compression is that hydrogen gas at a low pressure is oxidized at the anode, then oxidized hydrogen passes through the proton exchange membrane and reaches the cathode, where the oxidized hydrogen is reduced to the hydrogen gas at a high pressure. In this way, the compression of hydrogen is achieved. However, in an aqueous system, since protons generally do not exist in the state of bare atomic nuclei, protons generally form hydronium ions with surrounding water molecule aggregates, such as H₅O₂⁺ and H₉O₄⁺, and then transported to the cathode through the proton exchange membrane, so that water will continue to be carried from the anode to the cathode (the electroosmotic drag phenomenon), and after long-term use or under the high current density, the proton exchange membrane will have the problem of drying up of the anode side, making it difficult for hydrogen ions to combine with water molecules and pass through the proton exchange membrane. As a result, the proton transfer efficiency is greatly reduced or even the proton exchange membrane stops working. In addition, the moisture reduction at the anode side will also affect the Ohmic resistance of the membrane electrode, which generally leads to an increase in the resistance of the membrane electrode and a decrease in conductivity, and in turn affects the efficiency of electrochemical hydrogen compression. Such problems also arise in the field of fuel cells and the like.

In order to prevent the anode side from drying up, people have made many improvements to the proton exchange membrane, to which a water-retaining material such as TiO₂ and zirconium phosphate is commonly added. However, these water-retaining materials only have the function of water absorption and water retention, but still have the electroosmotic drag problem, and a large number of water molecules are still carried from the anode to the cathode during the transfer of every proton. These water-retaining materials are mostly granular and non-conductive, resulting in high membrane electrode resistance, low conductivity, and low efficiency of the proton transfer in use of the proton exchange membrane. Therefore, more effective water-retaining material and proton exchange membrane are needed to alleviate the drying up of the anode side, reduce the electroosmotic drag problem, and improve the proton transfer efficiency.

The purpose of this application is to overcome the above-mentioned deficiencies in the prior art, and to provide a water-retaining material, a water-retaining proton exchange membrane, preparation methods and applications thereof, so as to solve the technical problems that the existing water-retaining material and proton exchange membrane has limited water retention effect, serious electroosmotic drag phenomenon, easily drying up of the anode side, increasing resistance, lowered proton transfer efficiency, etc.

To achieve the above objects, a first aspect of the present application provides a water-retaining material. The water-retaining material comprises: a polymer chain segment provided by a hydrophilic polymer; and a proton carrier group grafted to the polymer chain segment. The polymer chain segment contains a hydrophilic group.

The hydrophilic polymer chain segment contained in the water-retaining material according to embodiments of the present application contains a hydrophilic group, which endows the water-retaining material with a hydrophilic and water retention effect and reduces the loss of water molecules. The proton carrier group contained in the water-retaining material promotes the formation of various hydrogen bonds and forms conjugate acid-base pairs, which promotes the transferring of protons through the hopping mechanism in many ways and reduces the proportion of the proton transferred through the transport mechanism, thereby inhibiting the electroosmotic drag phenomenon. When used in proton exchange membranes, the water-retaining material functions in water retention, preventing drying up of the anode side, reducing internal resistance, and improving the proton conductivity.

In some embodiments, the hydraulic group comprises at least one of a hydroxyl, an amino, an aldehyde, and a carboxyl.

In some embodiments, the proton carrier group comprises at least one of a photographic acid group, a carboxylic acid group, a sulfonic acid group, and a phenolic hydroxyl group.

In some embodiments, the proton carrier group is provided by at least one of 2-phosphonobutane-1,2,4-tricarboxylic acid, diethylphosphonoacetic acid, 4-aminobutyl phosphonic acid, and 4-phosphobutyric acid.

In some embodiments, the proton carrier group is grafted to the polymer chain segment via at least one of an ester group, an amide group, and an acid anhydride.

In some embodiments, the hydrophilic polymer comprises at least one of a chitosan, a chitosan derivative, a polyacrylic acid, and a hydrophilic polyamine.

A second aspect of the present application provides a method for preparing a water-retaining material. The method comprises:
performing, in a reaction system comprising an activator and a catalyst, a grafting reaction between a hydrophilic polymer and a proton carrier compound to yield the water-retaining material.

The water-retaining material contains a polymer chain segment containing a hydrophilic group.

In the preparation method of the water-retaining material according to embodiments of the present application, the proton carrier compound is grafted on the polymer chain segment of the hydrophilic polymer to obtain the water-retaining material, and the hydrophilic groups contained in the polymer chain segment make the water-retaining material have the hydrophilicity and water retention effect. The proton carrier group provided by the proton carrier compound facilitates the transferring of protons through the hopping mechanism in the water-retaining material. Thus, the prepared water-retaining material can inhibit the electroosmotic drag phenomenon while having water retention effect.

In some embodiments, the hydrophilic polymer and the proton carrier compound are mixed according to a molar ratio of between 5:1 and 1:20.

In some embodiments, the hydrophilic polymer comprises at least one of a chitosan, a chitosan derivative, a polyacrylic acid, a hydrophilic polyamine.

In some embodiments, the proton carrier compound comprises at least one of 2-phosphonobutane-1,2,4-tricarboxylic acid, diethylphosphonoacetic acid, 4-aminobutyl phosphonic acid, and 4-phosphobutyric acid.

In some embodiments, the grafting reaction comprises at least one of an esterification reaction, an amidation reaction, and an anhydride formation reaction.

In some embodiments, the reaction system comprises a solvent, and the solvent comprises at least one of dimethyl sulfoxide, N,N-dimethylformamide, tetrahydrofuran, N-methylpyrrolidone.

In some embodiments, the catalyst comprises at least one of 4-dimethylaminopyridine, 4-pyrrolidinylpyridine, and 9-azajulolidin.

In some embodiments, the activator comprises at least one of N,N′-dicyclohexylcarbodiimide, N-hydroxysulfosuccinimide, carbodiimide, and N,N′-diisopropylcarbodiimide.

In some embodiments, after the grafting reaction, the preparation method further comprises a step of purifying the water-retaining material, and the step of purifying the water-retaining material comprises:
washing, extracting, and dialyzing the water-retaining material.

A third aspect of the present application provides a water-retaining proton exchange membrane. The water-retaining proton exchange membrane comprises a matrix. The matrix is doped with a water-retaining material. The water-retaining material comprises the water-retaining material according to embodiments of the present application or the water-retaining material prepared by the method according to embodiments of the present application.

The water-retaining material and the matrix in the water-retaining proton exchange membrane according to embodiments of the present application play a complex synergistic effect. On the one hand, the hydrophilic and water retention effect of the water-retaining proton exchange membrane in embodiments of the present application can be improved, and the loss of water molecules can be reduced. On the other hand, the proportion of protons transferred by the hopping mechanism during proton transfer is improved, thereby inhibiting the electroosmotic drag phenomenon. Under such a comprehensive effect, the water-retaining proton exchange membrane reduces the amount of water molecules lost at the anode side during the proton transfer process, alleviates the drying up of the anode side, and improves the proton transfer efficiency.

In some embodiments, a material of the matrix comprises at least one of a perfluorosulfonic acid resin, a polyether ether ketone, a polybenzimidazole, a polyethersulfone polysulfone, and a polyimide.

In some embodiments, the water-retaining material accounts for between 0.1 wt. % and 50 wt. % of a total weight of the matrix and the water-retaining material.

In some embodiments, a doping amount of the water-retaining material in the matrix presents a gradient distribution from a surface of the matrix to another opposite surface of the matrix.

In some embodiments, the matrix comprises at least two base films, the doping amount of the water-retaining material in each of the at least two base films is different. In a direction from a surface of the matrix to another opposite surface, the at least two base films are stacked such that the water-retaining material presents a gradient distribution.

In some embodiments, a single base film has a thickness of between 5 μm and 50 μm.

In some embodiments, the water-retaining proton exchange membrane further comprises at least one reinforcing layer. The reinforcing layer is stacked between any two adjacent base films.

In some embodiments, a material of the reinforcing layer comprises at least one of an expanded polytetrafluoroethylene, a polyether ether ketone, and a carbon nanotube.

In some embodiments, a single reinforcing layer has a thickness of between 1 μm and 20 μm.

A fourth aspect of the present application provides a method for preparing a water-retaining proton exchange membrane. The method for preparing the water-retaining proton exchange membrane comprises steps of:
preparing a mixture solution by mixing a water-retaining material and a material of a matrix; and
performing at least one film formation on the mixture solution to obtain a water-retaining proton exchange membrane.

The water-retaining material comprises the water-retaining material according to embodiments of the present application or the water-retaining material prepared by the method according to embodiments of the present application.

The preparation method of the water-retaining proton exchange membrane according to embodiments of the present application can produce a water-retaining proton exchange membrane in which the water-retaining material is doped into the matrix, so that the water-retaining material can have complex synergistic effect on the matrix, and the prepared water-retaining proton exchange membrane has hydrophilic and water retention effect, reduces the loss of water molecules, and inhibits the electroosmotic drag phenomenon, thereby improving the proton transfer efficiency.

In some embodiments, the step of preparing the mixture solution comprises: preparing at least two mixture solutions having different concentrations of the water-retaining material according to different ratios of the water-retaining material to the material of the matrix; and
the step of performing at least one film formation comprises: enabling the at least two mixture solutions having different concentrations of the water-retaining material to form base films, respectively, and stacking the base films sequentially according to an order of a gradient distribution of the concentration of the water-retaining material.

In some embodiments, the film formation further comprises a step of adding a reinforcing layer.

A fifth aspect of the present application provides use of the water-retaining proton exchange membrane in electrochemical hydrogen compression, electrochemical carbon dioxide compression, electrochemical air compression, fuel cells, and hydrogen production from water electrolysis.

When the water-retaining proton exchange membrane is used in the field of electrochemical gas compression, the anode side is not easy to dry out, the compression efficiency is high, and the durability is good. When being used in the electrochemical hydrogen compressor, the water-retaining proton exchange membrane has the advantages of low internal resistance, high proton transfer rate, and fast release of electric energy. When being used in the hydrogen production from water electrolysis, the water-retaining proton exchange membrane also has low internal resistance, improved proton transfer rate, and improved hydrogen production efficiency.

A sixth aspect of the present application provides an electrochemical hydrogen compressor. The electrochemical hydrogen compressor comprises: an anode, a cathode, and a membrane electrode. The membrane electrode is arranged between the anode and the cathode. The membrane electrode comprises: a proton exchange membrane, catalyst layers, and a gas diffusion layer. The catalyst layer is arranged at two opposite surfaces of the proton exchange membrane. The gas diffusion layer is arranged on a surface of the catalyst layer away from the proton exchange membrane.

The proton exchange membrane comprises the water-retaining proton exchange membrane according to embodiments of the present application or the water-retaining proton exchange membrane prepared by the method according to embodiments of the present application.

In the hydrogen electrochemical compressor of embodiments of the present application, because the proton exchange membrane is a water-retaining proton exchange membrane, the anode side of the membrane electrode is not easy to dry up, the resistance is reduced, the proton transfer rate is high, the compression efficiency is high, and the durability is good.

In some embodiments, a side of the water-retaining proton exchange membrane having a higher doping amount of the water-retaining material is arranged adjacent to the anode.

### BRIEF DESCRIPTION OF THE DRAWINGS

In order to more clearly illustrate the detailed embodiments of the present application or technical proposals in the existing technology, accompanying drawings that are used in the description of the embodiments or existing technologies are briefly introduced hereinbelow. It is understood that the drawings in the following description are merely some embodiments of the present application. For those skilled in the art, other drawings can also be obtained according to these drawings without any creative effort.

FIGS. 1A-ID are a solid-state nuclear magnetic resonance (NMR) test spectrogram of a chitosan, a proton carrier compound, and a water-retaining material in Example A1 of the present application, in which, FIG. 1A is a ¹³C NMR test spectrogram of the hydrophilic polymer, the proton carrier compound, and the water-retaining material, FIG. 1B is ³¹P NMR test spectrogram of the water-retaining material; FIG. 1C is a ¹⁵N NMR test spectrum of the water-retaining material, and FIG. 1D is the functional group corresponding to each signal peak in the spectrogram.

FIG. 2 is a scanning electron micrograph of a water-retaining proton exchange membrane provided by Example B2;

FIG. 3 is test results of the electrical conductivity of proton exchange membranes provided by Example B1, Example B2, and Comparative Example B1 under different relative humidities;

FIG. 4 is test results of a current density in function of an applied voltage in the proton exchange membrane provided by Example B1, B2 and Comparative Example B1 under two relative humidities;

FIGS. 5A-5C are result graphs indicating the time and the pressure of compressed hydrogen pressure in electrochemical hydrogen compressors prepared by the proton exchange membranes provided by Example B1 and Comparative Example B1, respectively, under different voltages at 100% relative humidity,
in which, FIG. 5A is the result at the voltage of 0.4 V, FIG. 5B is the result at the voltage of 0.3 V, and FIG. 5C is the result at the voltage of 0.2 V;

FIGS. 6A-6C is result graphs indicating the time and the pressure of compressed hydrogen pressure in electrochemical hydrogen compressors prepared by the proton exchange membranes provided by Example B1 and Comparative Example B1, respectively, under different voltages at 100% relative humidity,
in which, FIG. 6A is the result at the voltage of 0.4 V, FIG. 6B is the result at the voltage of 0.3 V, and FIG. 6C is the result at the voltage of 0.2 V;

FIGS. 7A-7B are result graphs indicating the time and the pressure of compressed hydrogen pressure in electrochemical hydrogen compressors prepared by the water-retaining proton exchange membrane provided by Example B1 and Example B2, respectively, under different voltages at two relative humidities,
in which, FIG. 7A is the result at 100% relative humidity and the voltages of 0.4 V and 0.3 V, and FIG. 7B is the result at 50% relative humidity and the voltages of 0.4 V and 0.3 V;

FIG. 8 is a structural schematic diagram of a water-retaining proton exchange membrane according to an embodiment of the present application, in which, a doping amount of the water-retaining material is uniform;

FIG. 9 is a structural schematic diagram of a water-retaining proton exchange membrane according to an embodiment of the present application, in which, a doping amount of the water-retaining material is a gradient distribution;

FIG. 10 is a structural schematic diagram of a water-retaining proton exchange membrane provided by Example B1; and

FIG. 11 is a structural schematic diagram of a water-retaining proton exchange membrane provided by Example B2.

The reference numerals are as follows:
10—matrix; 11—base film; and 20—reinforcing layer.

### DETAILED DESCRIPTION OF THE EMBODIMENTS

In order to make the purpose, technical proposals, and advantages of the present application more clearly understood, the present application will be described in further detail hereinbelow with reference to the accompanying drawings and embodiments. It should be understood that the specific embodiments described herein are merely used to explain the present application, but not to limit the present application.

In this application, the term “and/or”, which describes the relationship between related objects, means that there can be three relationships, for example, A and/or B, which can represent circumstances that A exists alone, A and B exist at the same time, and B exists alone, where A and B can be singular or plural. The character “/” generally indicates that the associated objects are in an “or” relationship.

In this application, “at least one” means one or more, and “a plurality of” means two or more. “At least one item below” or similar expressions refer to any combination of these items, including any combination of single item or plural items. For example, “at least one of a, b, or c” or “at least one of a, b, and c” can mean: a, b, c, a-b (i.e., a and b), a-c, b-c, or a-b-c, where a, b, and c can be singular or plural respectively.

It should be understood that, in various embodiments of the present application, the numbers of the above-mentioned processes do not imply the sequence of execution, some or all of the steps may be executed in parallel or sequentially, and the execution sequence of each process should be based on its functions and determined by the internal logic, and should not constitute any limitation on the implementation process of the embodiments of the present application.

The terms used in the embodiments of the present application are merely for the purpose of describing specific embodiments, and are not intended to limit the present application. Unless clearly dictated otherwise, the singular forms “a”, “the” and “said” as used in the embodiments of this application and the appended claims intended to include the plural forms as well.

The weight of the relevant compositions mentioned in the examples of this application can not only refer to the specific content of each composition, but also represent the proportional relationship between the weights of the compositions. It is within the scope disclosed in the embodiments of the present application that the content of the compositions is proportionally scaled up or down. Specifically, the weight described in the description of the embodiments of the present application may be a weight unit known in the chemical field, such as μg, mg, g, and kg.

The terms “first” and “second” are merely used for descriptive purposes to distinguish objects such as substances from each other, and cannot be understood as indicating or implying relative importance or implying the number of indicated technical features. For example, without departing from the scope of the embodiments of the present application, “the first” may also be referred to as “the second”, and similarly, “the second” may also be referred to as “the first”. Thus, a feature defined as “first” or “second” may expressly or implicitly include one or more of the features.

A first aspect of the present application provides a water-retaining material. The water-retaining material comprises: a polymer chain segment provided by a hydrophilic polymer; and a proton carrier group grafted to the polymer chain segment. The polymer chain segment contains a hydrophilic group.

Proton transfer mechanism mainly includes hopping mechanism, transport mechanism, and the like. The inventors have found from their research that the main reason why an anode side of the existing proton exchange membrane is easy to dry up is that the current proton transfer mainly relies on the transport mechanism, which has serious electroosmotic drag phenomenon. First, the transport mechanism is that protons forms H₅O₂⁺, H₉O₄⁺, and the like in water. H₅O₂⁺ is in the form of a proton located between two water molecules, and H₉O₄⁺ is in the form that H₃O⁺ is located at a center and connected to three water molecules. Protons and water molecules are transported in the form of complex ions like freight cars, thus, a large amount of water molecules are needed during the transfer of protons in order to pass through the proton exchange membrane, resulting in a loss of water molecules on one side. Second, the proton transfer in the existing proton exchange mechanism also involves the hopping mechanism, which is carried out through hydrogen bonds. For example, in the hydrogen bond chain H₂O—H₂O—H₂O composed of water molecules, the proton is initially located on the leftmost side, forming a complex ion H₃O⁺, and then the proton jumps from the right to the adjacent H₂O molecule, making the neutral H₂O become a positively charged H₃O⁺, and the previously H₃O⁺ in the left loses the proton and becomes a neutral H₂O molecule, in this way, the proton will be transferred along the hydrogen bonds. In the hopping mechanism, the carrier (H₂O) itself does not move, but completely relies on the hopping of H⁺ among the carriers to complete the charge transport process. Proton exists in the form of H₃O⁺ for most of the time, and only exists in an independent H; state at the moment of hopping among hydrogen bonds, which makes the hopping mechanism independent of the carrier's motion in transporting protons. The hydrogen bonding chain of water molecules is just one example. The hopping mechanism exists in many active groups with hydrogen bonds, and the proton transfer effect is related to the type of groups and the distance between groups. For example, the proton exchange membrane made from the perfluorosulfonic acid resin, a small amount of protons will undergo the hopping mechanism transmission through hydrogen bonds such as sodium acid group—water—sodium acid group or sodium acid group—sodium acid group.

The inventors have studied and found that the hydraulic polymer chain segment of the water-retaining material in embodiments of the present application contains the hydraulic group, so the water-retaining material has a basic hydrophilic and water retention effect and reduces the loss of water molecules. The water-retaining material contains the proton carrier group grafted on the polymer chain segment, thereby increasing the proportion of protons transported by the hopping mechanism. Specifically, hydrogen bonds of different strengths may be formed between mutual proton carrier groups, between the proton carrier group and water molecules, between the proton carrier group and the hydraulic group, and between the proton carrier group and the polymer chain segment to form a variety of proton hopping channels, thereby reducing the activation energy required for proton hopping transfer. In addition, the proton carrier group can dissociate protons and then receive protons again to form conjugate acid-base pairs, which facilitates the transfer of protons through the hopping mechanism. This promotes protons to be transferred through the hopping mechanism in many ways, improves the effect of the proton transfer, and the hopping mechanism does not require water molecule movement when transferring the protons, so that the water-retaining material in embodiments of the present application has water retention effect, in the meantime, increases the proportion of the proton transfer through the hopping mechanism, and reduces the proportion of the proton transfer through the transport mechanism, thereby inhibiting the electroosmotic drag phenomenon, and when being used in the proton exchange membrane, the water-retaining material may function in retaining water, preventing the anode side from drying up, reducing the internal resistance, and improving the effect of proton conductivity.

In some embodiments, the hydraulic group may comprise at least one of a hydroxyl, an amino, an aldehyde, and a carboxyl. The hydraulic group has good hydrophilicity, making the water-retaining material have good hydrophilic and water retention effect. Moreover, the hydraulic group can form a hydrogen bond with the proton carrier group, thereby reducing the activation energy required for proton hopping transfer, and promoting the proton to undergo the hopping transfer.

In some embodiments, the proton carrier group may comprise at least one of a photographic acid group, a carboxylic acid group, a sulfonic acid group, and a phenolic hydroxyl group. On the one hand, the proton carrier groups can form various kinds of hydrogen bonds in the water-retaining material to form the proton hopping channels; on the other hand, such proton carrier groups can dissociate protons and then receive protons again to form conjugate acid-base pairs, such that the water-retaining material inhibits the electroosmotic drag phenomenon and improves proton conductivity.

In some embodiments, the proton carrier group may be provided by at least one of 2-phosphonobutane-1,2,4-tricarboxylic acid, diethylphosphonoacetic acid, 4-aminobutyl phosphonic acid, and 4-phosphobutyric acid. These materials are rich in the proton carrier group, such as the phosphoric acid group, the carboxylic acid group, the sulfonic acid group, and the phenolic hydroxyl group in the above, so that the water-retaining material promotes the transfer of protons through the hopping mechanism, and inhibits the electroosmotic drag phenomenon. When the material contains a variety of proton carrier group, the improvement effect is most obvious, for example, 2-phosphonobutane-1,2,4-tricarboxylic acid (PBTCA) can simultaneously introduce the proton groups including carboxyl and the phosphoric acid group, and the resulting water-retaining material can obviously improve the proton conductivity of the proton exchange membrane.

In some embodiments, the proton carrier group may be grafted to the polymer chain segment via at least one of an ester group, an amide group, and an acid anhydride. These grafting groups are obtained from an original part of the hydraulic group in the hydrophilic polymer and the proton carrier group, through the esterification reaction, the amidation reaction, and the anhydride formation reaction, so as to improve the stability of combination between the proton carrier group and the hydrophilic polymer.

In some embodiments, the hydrophilic polymer may comprise at least one of a chitosan, a chitosan derivative, a polyacrylic acid, and a hydrophilic polyamine. These hydraulic polymers are rich in the hydraulic group, have good hydrophilic and water retention effect, and can be grafted efficiently and stably with the proton carrier group, and a part of the hydraulic group can form hydrogen bonds with the proton carrier group to reduce the activation energy required for proton hopping transfer to facilitate the transfer of protons through the hopping mechanism. Therefore, the hydrophilic polymer can improve the water retention effect of the water-retaining material and inhibit the electroosmotic drag phenomenon. For example, when the chitosan is grafted with 2-phosphonobutane-1,2,4-tricarboxylic acid, the carboxyl contained in 2-phosphonobutane-1,2,4-tricarboxylic acid can be grafted with the alcohol group and the amino contained in the chitosan, in which, the carboxyl and the alcohol group are dehydrated to form the ester group, and the carboxyl and the amino group are dehydrated to form the amide group, thus generating the water-retaining material.

A second aspect of the present application provides a method for preparing a water-retaining material. The method comprises:

Step S01: performing, in a reaction system comprising an activator and a catalyst, a grafting reaction between a hydrophilic polymer and a proton carrier compound to yield the water-retaining material.

The water-retaining material contains a polymer chain segment containing a hydrophilic group.

In the preparation method of the water-retaining material in embodiments of the present application, grafting reaction is carried out between the hydraulic polymer and the proton carrier compound, so that the proton carrier group is tightly grafted on the hydraulic polymer, and the polymer chain segment in the prepared water-retaining material contains the hydrophilic group, which has hydrophilic and water retention effect. The proton carrier group provided by the proton carrier compound promotes the formation of various hydrogen bonds in the water-retaining material to form proton hopping channels, thereby reducing the activation required for proton hopping transfer. The proton carrier group can form conjugate acid-base pairs to facilitate the transfer of protons through the hopping mechanism. Thus, the prepared water-retaining material can inhibit the electroosmotic drag phenomenon while having water retention effect. In order to promote the grafting reaction, the raw materials can be fully stirred at between 60° C. and 90° C. In the example, the reaction can be carried out at typical but non-limiting temperatures such as 60° C., 70° C., 80° C., and 90° C.

In some embodiments, the hydrophilic polymer may comprise at least one of a chitosan, a chitosan derivative, a polyacrylic acid, a hydrophilic polyamine.

In some embodiments, the proton carrier compound may comprise at least one of 2-phosphonobutane-1,2,4-tricarboxylic acid, diethylphosphonoacetic acid, 4-aminobutyl phosphonic acid, and 4-phosphobutyric acid.

In some embodiments, the grafting reaction may comprise at least one of an esterification reaction, an amidation reaction, and an anhydride formation reaction.

The hydraulic polymer is rich in hydraulic groups (such as alcohol group, amino, carboxyl), the proton carrier compound is rich in the proton carrier groups (such as the phosphoric acid group and the carboxyl), thus the proton carrier compound can be efficiently and stably grafted on the hydraulic polymer via the esterification reaction, the amidation reaction, the anhydride fonnation reaction, for example, the esterification reaction where the alcohol group and the proton carrier group are dehydrated, the amidation reaction where the amino group and the proton carrier group are dehydrated, or the anhydride formation reaction where carboxyl and the proton carrier group are dehydrated. In the water-retaining material obtained after grafting, the hydraulic group on the polymer chain segment has hydrophilic and water retention effect, and the remaining proton carrier group can promote the formation of various hydrogen bonds in the water-retaining material to promote the transfer of protons by the hopping mechanism. Therefore, these raw materials and the grafting methods are conducive to improving the hydrophilic and water retention effect of the water-retaining material and inhibiting the electroosmotic drag phenomenon.

In some embodiments, the hydrophilic polymer and the proton carrier compound may be mixed according to a molar ratio of between 5:1 and 1:20. Considering the degree of reaction of the respective group in the grafting reaction of the preparation method, such proportion of the hydraulic polymer to the proton carrier compound allows to fully carry out the grafting reaction, and in the water-retaining material obtained after the grafting reaction, the remaining hydraulic group and the proton carrier group can reach a certain amount to retain water and inhibit the electroosmotic drag phenomenon. In the example, the molar ratio of the hydraulic polymer to the proton carrier compound can be (5:1), (3:1), (1:1), (1:5), (1:10), (1:20) and other typical and non-limiting ratios.

In some embodiments, the reaction system may comprise a solvent, and the solvent comprises at least one of dimethyl sulfoxide, N,N-dimethylformamide, tetrahydrofuran, N-methylpyrrolidone. These solvents are used to dissolve the hydraulic polymer and the proton carrier compound, so that the raw materials can be uniformly mixed and dispersed, and the grafting reaction ratio can be increased.

In some embodiments, the catalyst may comprise at least one of 4-dimethylaminopyridine, 4-pyrrolidinvlpyridine, and 9-azajulolidin.

In some embodiments, the activator may comprise at least one of N,N′-dicyclohexylcarbodiimide, N-hydroxysulfosuccinimide, carbodiimide, and N,N′-diisopropylcarbodiimide.

The activator can promote the dissociation of the proton carrier group, make the proton combine with the activator, and enable the proton carrier group to be grafted on the hydrophilic group such as alcohol, amino, and the like, under the action of the catalyst. In the process, the activator also plays a role in promoting dehydration between groups, thereby promoting the esterification reaction, the amidation reaction, and the anhydride formation reaction. Therefore, the catalyst and the activator can increase the activity of the functional groups in the hydraulic polymer and the proton carrier compound, and promote the grafting reaction.

In some embodiments, after the grafting reaction, the preparation method may further comprise a step of purifying the water-retaining material, and the step of purifying the water-retaining material comprises: washing, extracting, and dialyzing the water-retaining material.

After the grafting reaction, in addition to the water-retaining material required, the mixture also includes the solvent, the catalyst, the dehydrating agent, and the proton carrier compound, etc., in order to improve the purity and the nature of the obtained water-retaining material, the resulting mixture can be further purified, washed with deionized water, extracted to remove the activator, and dialyzed to remove the proton carrier compound, the solvent, and the catalyst residue.

A third aspect of the present application provides a water-retaining proton exchange membrane. As some embodiments of the present application, as shown in FIGS. 8-11, the water-retaining proton exchange membrane according to embodiments of the present application comprises a matrix. The matrix is doped with a water-retaining material. The water-retaining material comprises the water-retaining material according to embodiments of the present application or the water-retaining material prepared by the method according to embodiments of the present application.

The matrix 10 in the absence of doped water-retaining material, that is, the proton exchange membrane in the prior art, has the property of allowing water and protons to pass through and preventing other microscopic particles from passing through. The water-retaining proton exchange membrane of embodiments of the present application is added with the water-retaining material to have complex synergistic effect with the matrix 10. The water-retaining proton exchange membrane in embodiments of the present application not only has the improved hydrophilic and water retention effect, but also has increased proportion of protons transferred through the hopping mechanism during the proton transfer process, thereby inhibiting the electroosmotic drag phenomenon. Under such a comprehensive effect, the water-retaining proton exchange membrane reduces the amount of water molecules lost on the anode side during the proton transfer process, alleviates the phenomenon of drying up on the anode side, and improves the proton transfer efficiency. The inventors have tested that the water-retaining proton exchange membrane in embodiments of the present application has stable water distribution on the anode side during use, reduced membrane electrode resistance, increased electrical conductivity, and improved the proton transfer efficiency. The matrix 10 can be a whole structure, or a multi-layer structure as shown in FIG. 8 and FIG. 9.

In some embodiments, a material of the matrix may comprise at least one of a perfluorosulfonic acid resin, a polyether ether ketone, a polybenzimidazole, a polyethersulfone polysulfone, and a polyimide. The material of the matrix 10 endow the proton exchange membrane with the property of enabling the water and protons to pass through while isolating other microscopic particles. For example, the Nafion membrane made of the perfluorosulfonic acid resin contains a large number of sulfonic acid groups (—SO₃H) in the microstructure, which can provide free protons and attract water molecules. After the Nafion membrane is swollen with water, transfer channels for the protons and water are formed microscopically.

In some embodiments, the water-retaining material may account for between 0.1 wt. % and 50 wt. % of a total weight of the matrix and the water-retaining material.

After research by the inventor, the proportion of the water-retaining material within a certain range is ideal for water retention effect and the effect of inhibiting the electroosmotic drag. When the water-retaining material accounts for less than 0.1 wt. % of a total weight of the matrix and the water-retaining material, the content of the water-retaining material in the entire matrix 10 is too low, so the effect of water retention and inhibition of the electroosmotic drag is weak, and the drying up of the anode side cannot be significantly tackled. Moreover, the content of the water-retaining material cannot be too high, since the water-retaining material itself does not have the effect of isolating microscopic particles other than water and protons, when the water-retaining material accounts for higher than 50 wt. % of the total weight of the matrix 10 and the water-retaining material, some other microscopic particles can pass through the proton exchange membrane, causing the proton exchange membrane to lose the basic isolation effect. In an example, the water-retaining material may account for 0.1 wt. %, 0.25 wt. %, 0.5 wt. %, 1 wt. %, 5 wt. %, 10 wt. %, 20 wt. %, 30 wt. %, 40 wt. %, 50 wt. % and other typical and non-limiting ratios, of the total weight of the matrix 10 and the water-retaining material.

In some embodiments, a doping amount of the water-retaining material in the matrix 10 may present a gradient distribution from a surface of the matrix 10 to another opposite surface of the matrix 10.

From the research of the inventors, as shown in FIG. 8, when the doping amount of the water-retaining material in the matrix 10 is uniform, the water-retaining proton exchange membrane is proved to have the corresponding improvement effect as described in the above. After further research, a gradient distribution of the doping amount of the water-retaining material makes the two opposite surfaces of the water-retaining proton exchange membrane have different attraction effects on water. After the water-retaining proton exchange membrane is fully wetted, water is prone to be concentrated on the side having a higher doping amount of the water-retaining material, and not easy to be transferred to the other side having a lower doping amount of the water-retaining material, thereby playing an effect similar to “reverse osmosis”. Therefore, the gradient distribution has a synergistic effect on the use of the water-retaining material in the water-retaining proton exchange membrane. In addition to the effect of water retention and inhibition of the electroosmotic drag brought by the water-retaining material itself, the arrangement of the gradient distribution further preserves water on one side and further inhibits the electroosmotic drag phenomenon. The gradient distribution here can be various, which can be a continuous gradient, from one surface of the matrix 10 to the opposite surface, with the doping amount gradually changes from low to high, and can also be a multi-layered gradient having the doping amount intermittently change, both the two kinds of gradients are involved in the gradient distribution.

For example, in some embodiments, as shown in FIG. 9, the matrix 10 may comprise at least two base films 11, the doping amount of the water-retaining material in each of the at least two base films 11 is different. In a direction from a surface of the matrix 10 to another opposite surface, the at least two base films 11 are stacked such that the water-retaining material presents a gradient distribution.

Herein, the matrix 10 may include at least two base films 11. The doping amount within the same layer of each base film 11 is the same, but gradually increases in a gradient manner among different layers of base films. Such water-retaining proton exchange membrane having the at least two base films 11 in a gradient distribution manner has stable property and obvious gradient levels, and obvious improvement in water retention and inhibition of the electroosmotic drag. In an example, the number of base films can be 2, 3, 4, and 5, etc. layers, which are typical and non-limiting. In order to achieve such an effect, the thickness of the single-layer base film 11 may be between 1 μm and 50 μm. In an example, the thickness of the single base film 11 can be 1 μm, 5 μm, 10 μm, 20 μm, 30 μm, 40 μm, 50 μm, etc., which are typical and non-limiting.

In some embodiments, as shown in FIG. 10 or 11, the water-retaining proton exchange membrane may further comprise at least one reinforcing layer 20. The reinforcing layer 20 is stacked between any two adjacent base films 11.

The reinforcing layer 20 can improve the mechanical property of the water-retaining proton exchange membrane, because in practical applications, the pressure on both sides of the proton exchange membrane is often different and unstable, so the proton exchange membrane needs to have a certain mechanical strength to improve stability without affecting the property. Especially in the application of electrochemical hydrogen compression, under the action of high-pressure hydrogen at the cathode and low-pressure hydrogen at the anode, the pressure difference exerted on the proton exchange membrane is very large, and the mechanical property of the water-retaining proton exchange membrane can be improved by providing the reinforcing layer 20, thus the stability of the water-retaining proton exchange membrane is improved. The number of the reinforcing layer 20 can be at least one. In an example, the number of the reinforcing layer 20 can be 1, 2, 3, etc., which are typical but non-limiting. The reinforcing layer 20 can be stacked between any two adjacent base films 11. Such stacking and binding manner enables the reinforcing layer 20 to have stable binding effect in the water-retaining proton exchange membrane, the water-retaining proton exchange membrane has significantly improved mechanical property and is much easier to be prepared.

In some embodiments, a material of the reinforcing layer 20 may comprise at least one of an expanded polytetrafluoroethylene, a polyether ether ketone, and a carbon nanotube.

In addition to the effect of improving the mechanical properties of the water-retaining proton exchange membrane, such material makes the reinforcing layer 20 have the effect of preventing particles, such as hydrogen, from passing through. For example, in the application of electrochemical hydrogen compression, the high-pressure hydrogen at the cathode may penetrate towards the anode, reducing the effect of hydrogen compression. The reinforcing layer 20 made of such material can prevent the penetration of hydrogen, endow the water-retaining proton exchange membrane with good mechanical property, prevent the penetration of some microscopic particles.

In some embodiments, a single reinforcing layer may have a thickness of between 1 μm and 20 μm.

The single reinforcing layer 20 should not be too thin, which may otherwise fail to achieve the effect of enhancing mechanical property, nor too thick, which may otherwise avoid the proton transfer efficiency. Such thickness endows the reinforcing layer 20 with sufficient mechanical property. When the reinforcing layer 20 adopts the above materials, the above thickness also endows the reinforcing layer 20 with sufficient effect of preventing particles such as hydrogen gas from passing through. In an example, the thickness of the reinforcing layer 20 may independently be 1 μm, 5 μm, 10 μm, 15 μm, 20 μm, which are typical but non-limiting.

A fourth aspect of the present application provides a method for preparing a water-retaining proton exchange membrane. The method for preparing the water-retaining proton exchange membrane comprises:

Step S02: preparing a mixture solution by mixing a water-retaining material and a material of a matrix 10; and

Step S03: performing at least one film formation on the mixture solution to obtain a water-retaining proton exchange membrane.

The water-retaining material comprises the water-retaining material according to embodiments of the present application or the water-retaining material prepared by the method according to embodiments of the present application.

The preparation method in embodiments of the present application can produce the water-retaining proton exchange membrane in which the water-retaining material is doped into the matrix 10, so that the water-retaining material can have complex synergistic effect on the matrix 10, and the prepared water-retaining proton exchange membrane has hydrophilic and water retention effect, reduces the loss of water molecules, and inhibits the electroosmotic drag phenomenon, thereby improving the proton transfer efficiency.

When preparing the mixture solution in step S02, water and alcohol can be selected as solvents, for example, water and isopropanol are prepared in a ratio of 1:2, and are used to mix the water-retaining material and the material of the matrix 10. The material of the matrix 10 is at least one of the perfluorosulfonic acid resin, the polyether ether ketone, the polybenzimidazol, the polyethersulfone polysulfone, and the polyimide according to embodiments as described in the above.

When the doping amount of the water-retaining material in the water-retaining proton exchange membrane is uniform, a mixture solution having a uniform concentration of the water-retaining material can be prepared in step S02, and then at least one film formation is performed in step S03 to obtain the water-retaining proton exchange membrane having a uniform doping of the water-retaining material. At least one film formation treatment can be performed firstly to provide a substrate (such as the PI film made by the polyimide, or glass, etc.), and then a sophisticated coating device is used to coat the mixture solution on the substrate to form a coating, the step of which can be repeatedly performed on the coating. During the process, according to the concentration and solidification of the solution, the coating can be preliminarily solidified and formed at room temperature before a next time coating. After that, a resulting costing can be preliminarily dried at 70° C. to 90° C., then heated at 120° C. to 200° C. for between 0.5 hr and 2 hrs, and then peeled off from the substrate after cooling down, so as to obtain the water-retaining proton exchange membrane having a uniform doping amount of the water-retaining material, as shown in FIG. 8.

When the doping amount of the water-retaining material in the water-retaining proton exchange membrane is a gradient distribution, in some embodiments, the operation of preparing the mixture solution in step S02 includes: mixing the water-retaining material and the material of the matrix 10 according to different formulations so as to prepare two or more mixture solutions with different concentrations of the water-retaining material; and the operation of performing at least one film formation in step S03 may include: coating mixture solutions having different concentrations of the water-retaining material in sequence according an order of the gradient distribution of the concentration of the water-retaining material, so as to form the coatings having the concentration of the water-retaining materials in the gradient distribution. The provision of the substrate, the drying and heating methods can be referred to the above, and the water-retaining proton exchange having the gradient distribution of the concentration of the water-retaining material can be obtained after being peeled from the substrate, as shown in FIG. 9.

In some embodiments, the film formation may further comprise a step of adding a reinforcing layer 20.

In order to incorporate the reinforcing layer 20, the film formation can be performed at least twice, and the reinforcing layer 20 is arranged between any two adjacent coatings during the coating process with the solution. The reinforcing layer 20 can be frilly soaked in the mixture solution first, so as to reduce the influence of the reinforcing layer 20 on the efficiency of the proton exchange, and finally the coating including the reinforcing layer 20 can be dried and heated to finally obtain the water-retaining proton exchange membrane including the reinforcing layer 20.

A fifth aspect of the present application provides use of the water-retaining proton exchange membrane in electrochemical hydrogen compression, electrochemical carbon dioxide compression, electrochemical air compression, fuel cells, and hydrogen production from water electrolysis.

The water-retaining proton exchange membrane has the effect of hydrophilic and water retention and reducing the loss of water molecules, and can inhibit the electroosmotic drag phenomenon in the application, reduce the amount of water molecules lost at the anode side during the proton transfer process, and relieve the phenomenon of drying up of the anode side, reduce the resistance, and improve the proton transfer efficiency. Especially in the field of electrochemical gas compression, the anode side is not easy to dry out, the compression efficiency is high, and the durability is good. In fuel cell applications, the water-retaining proton exchange membrane also has the advantages of low internal resistance, high proton transfer rate, and fast power release. In the application in the hydrogen production from water electrolysis, the water-retaining proton exchange membrane has the advantages of low internal resistance, improved proton transfer rate, and improved hydrogen production rate.

A sixth aspect of the present application provides an electrochemical hydrogen compressor. The electrochemical hydrogen compressor comprises: an anode a cathode, and a membrane electrode. The membrane electrode is arranged between the anode and the cathode. The membrane electrode comprises: a proton exchange membrane, catalyst layers, and a gas diffusion layer. The catalyst layer is arranged at two opposite surfaces of the proton exchange membrane. The gas diffusion layer is arranged on a surface of the catalyst layer away from the proton exchange membrane. The proton exchange membrane comprises the water-retaining proton exchange membrane according to embodiments of the present application or the water-retaining proton exchange membrane prepared by the method according to embodiments of the present application.

In the electrochemical hydrogen compressor, the low-pressure hydrogen is oxidized into hydrogen ions at the anode, which is transferred to the cathode through the membrane electrode and reduced to high-pressure hydrogen, thereby achieving the effect of hydrogen compression. The proton exchange membrane in the membrane electrode allows protons and water molecules to pass through and isolate other particles; the catalyst layer is used to promote the anode and cathode reactions; and the gas diffusion layer supports the catalyst layer, collects current, and conducts gas.

The water-retaining proton exchange membrane has the hydrophilic and water retention effect and reduces the loss of water molecules, and can inhibit the electroosmotic drag phenomenon, reduce the amount of water molecules lost at the anode side during the proton transfer process, relieve the phenomenon of drying up of the anode side, reduce the resistance, and improve the proton transfer efficiency. Therefore, in the hydrogen electrochemical compressor in embodiments of the present application, the anode side of the membrane electrode is not easy to dry up, the resistance is reduced, the compression efficiency is high, and the durability is good.

In some embodiments, for the water-retaining proton exchange membrane of the electrochemical hydrogen compressor, the doping amount of the water-retaining material is distributed in a gradient, and the side having a higher doping amount of the water-retaining material may be close to the anode.

Since the doping amount of the water-retaining material in the proton exchange membrane has a gradient distribution, which can further inhibit the electroosmotic drag phenomenon, alleviate the phenomenon of drying up of the anode side, reduce the resistance of the membrane electrode, and increase the proton transfer rate, thus making the electrochemical hydrogen compressor compress have higher efficiency and better durability.

The water-retaining material, the water-retaining proton exchange membrane and their preparation methods of the embodiments of the present application are illustrated below through a number of specific examples.

### 1. Water-Retaining Material and Preparation Method Thereof

### Example A1

This example provides a water-retaining material and a preparation method thereof.

In this example, the water-retaining material was prepared by grafting 2-phosphonobutane-1,2,4-tricarboxylic acid (as a proton carrier compound) on a chitosan (as a hydraulic polymer), and the preparation method was conducted as follows:

### S1. Esterification and Amidation Reactions

3.236 g of a chitosan (0.02 mol) and 5.4026 g of
2-phosphonobutane-1,2,4-tricarboxylic acid (0.02 mol) were collected and added to 87.2 g of dimethyl sulfoxide, stirred at room temperature for 4 hrs until a resulting mixture was stirred uniform. After that, 0.5 g of 4-dimethylaminopyridine (as a catalyst) and 3.0 g of N,N′-dicyclohexylcarbodiimide (as an activator) were added, and stirred at 80° C. for 12 hrs to fully react the raw materials in the mixed solution, so as to obtain a mixture containing the water-retaining material. The chemical reaction formula of reaction in step S1 is as follows:

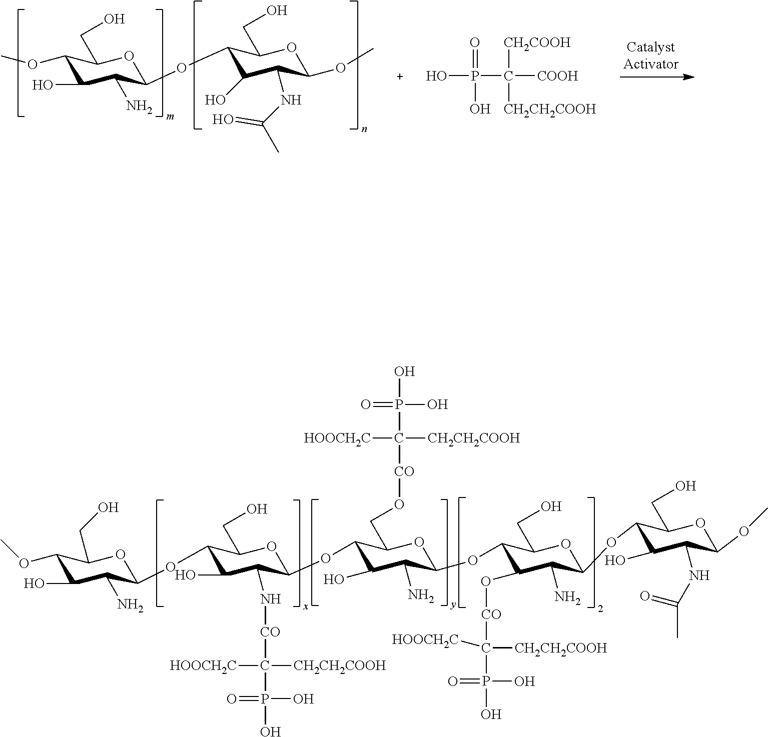

### S2. Removal of Impurities

The mixture containing the water-retaining mnaterial was fully washed with deionized water and further purified by extraction to remove the activator. Thereafter, dialysis (between 8000 g/mol and 14000 g/mol of a molar weight) was performed to further remove 2-phosphonobutane-1,2,4-tricarboxylic acid, dimethyl sulfoxide, and the catalyst, so as to obtain the water-retaining material.

### 2. Water-Retaining Proton Exchange Membrane and Preparation Method Thereof:

### Example B1

This example provides a water-retaining proton exchange membrane and reparation method thereof

As shown in FIG. 10, a water-retaining proton exchange membrane in this example includes a matrix. The water-retaining proton exchange membrane also contains the water-retaining material provided by Example A1, and the water-retaining material is doped in the matrix. The material of the matrix is the perfluorosulfonic acid resin. The substrate has a thickness of 75 μm, including two base films having thicknesses of 25 μm and 50 μm, respectively; and in the two base films, the water-retaining material accounts for 2.5 wt. % of a total weight of each base film. The water-retaining proton exchange membrane further includes a reinforcing layer, which is made of an expanded polytetrafluoroethylene and has a thickness of 25 μm. The reinforcing layer is stacked between the two base films, and the total thickness of the water-retaining proton exchange membrane is 100 μm.

The preparation method was as follows:

### S3. Preparation of Mixture Solution

The water-retaining material prepared by Example A1 and the perfluorosulfonic acid resin were mixed at a weight ratio of 2.5:97.5, dissolved in a mixed solvent of water and isopropanol, and fully stirred to obtain a mixture solution.

### S4. Film Formation

API film made of the polyimide was provided as a substrate, the mixture solution was applied with a scraper coating device onto the substrate to form a first layer of solution having a thickness of 25 μm, which was immediately covered with an expanded polytetrafluoroethylene having a thickness of 25 μm as a reinforcing layer. Herein, the reinforced layer was fully soaked in the mixture solution in advance to avoid adversely affecting the proton transfer, and then a second layer of solution having a thickness of 50 μm was applied on top of the reinforced layer with the scraper coating device, and the first layer of solution and the second layer of solution were preliminarily solidified and formed at room temperature, then a resulting product as a whole was placed into an oven to dry at 80° C. for 10 mins, and finally heated at 160° C. for 1.5 hrs. After being cooled down, a water-retaining proton exchange membrane formed was peeled off from the substrate.

### Example B2

This example provides a water-retaining proton exchange membrane and preparation method thereof.

As shown in FIG. 11, the water-retaining proton exchange membrane of this example is different from Example B1 in that: the water-retaining proton exchange membrane includes a matrix including three base films, with each base film having a thickness of 25 pin. Each base film contains the water-retaining material provided by Example A1, which accounts for 5 wt. %, 2.5 wt. %, and 1 wt. % of a total weight of the corresponding one base film, respectively. In a direction from a surface of the matrix to another opposite surface, the doping amount of the water-retaining material increases in a gradient. In the water-retaining proton exchange membrane further includes a reinforcing layer. The material and thickness of the reinforcing layer are the same as those in Example B1. The reinforcing layer is stacked between two base films containing between 5 wt. % and 2.5 wt. % of the water-retaining material. The entire water-retaining proton exchange membrane has a total thickness of 100 μm.

The difference between the preparation method of the water-retaining proton exchange membrane and that of Example B1 is as follows:

### S3. Preparation of the Mixture Solution

The water-retaining material and the perfluorosulfonic acid resin were mixed according to a weight ratio of 5:95 (referred to as a ratio a), 2.5:97.5 (referred to as a ratio b), 1:99 (referred to as a ratio c), and then resulting mixtures were respectively dissolved in a mixed solvent of water and isopropanol, fully stirred and mixed to obtain three mixture solutions of three concentrations, which are referred to as a solution a, a solution b, and a solution c in turn.

### S4. Film Formation

A PI film made of the polyimide was provided as a substrate, the mixture solution was applied with a scraper coating device onto the substrate to form a layer of solution a having a thickness of 25 μm, which was immediately covered with an expanded polytetrafluoroethylene having a thickness of 25 μm as a reinforcing layer. Herein, the reinforced layer was fully soaked in the solution b in advance to avoid negatively affecting the proton transfer, and then a layer of the solution b having a thickness of 25 μm was applied on top of the reinforced layer with the scraper coating device, and the layer of the solution a and the layer of the solution b were preliminarily solidified and formed at room temperature, and a layer of the solution c having a thickness of 25 μm was then coated on the surface of the layer of the solution b, thereafter, a resulting product as a whole was placed into an oven to dry at 80° C. for 10 mins, and finally heated at 160° C. for 1.5 hrs. After being cooled down, a formed water-retaining proton exchange membrane was peeled off from the substrate.

### Comparative Example B1

This comparative example provides a proton exchange membrane, specifically a Nafion membrane made of the perfluorosulfonic acid resin, including a layer of perfluorosulfonic acid resin having a thickness of 50 μm and a layer of the perfluorosulfonic acid resin having a thickness of 25 μm. A reinforcing layer is arranged between the two layers of the perfluorosulfonic acid resin, thereby forming a commercialized Nafion XL membrane, in which the reinforcing layer is 25 μm thick, the reinforcing layer material is the expanded polytetrafluoroethylene, and the entire proton exchange membrane has a thickness of 100 μm.

For the convenience of expression, the proton exchange membranes of Example B1, Example B2, and Comparative Example B1 are successively recorded as membrane X, membrane Y, and membrane Z.

### 3. Material Characterization

### 3.1 Related Characterization of Water-Retaining Material

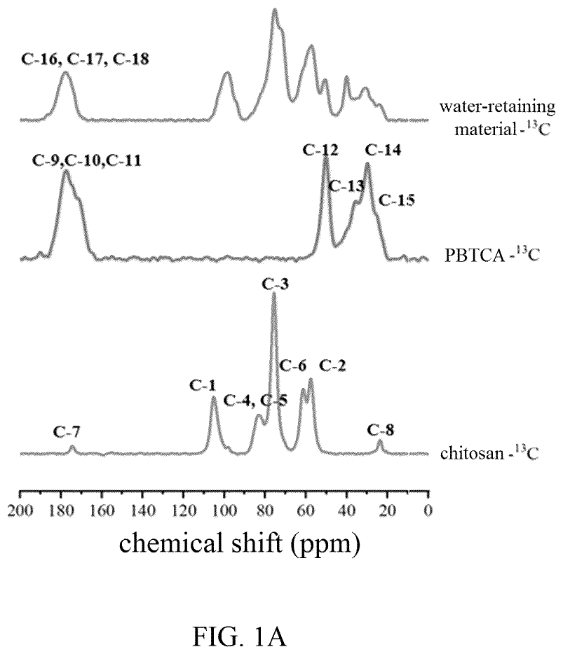

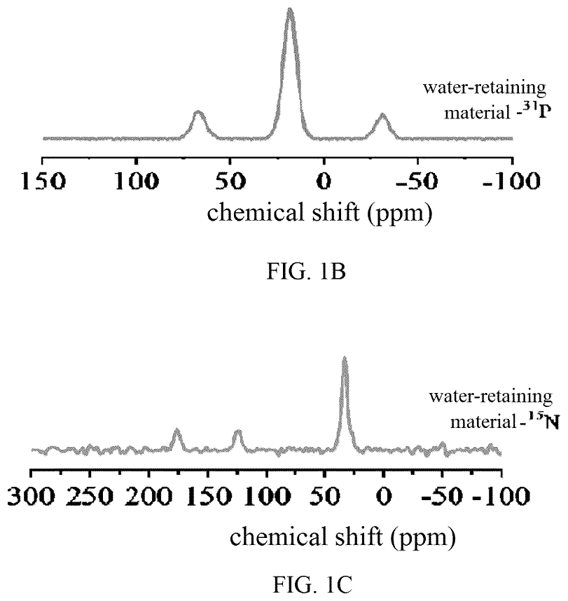

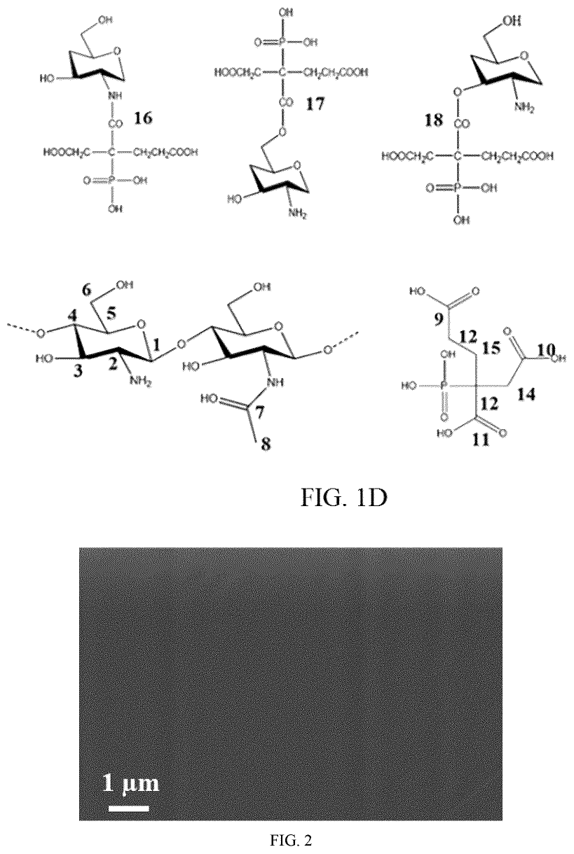

A chitosan, a proton carrier compound, and a water-retaining material prepared in Example A1 were tested by a solid-state NMR. The test spectrogram is shown in FIG. 1A-ID, FIG. 1A is a ¹³C NMR test spectrogram of the hydrophilic polymer, the proton carrier compound, and the water-retaining material, FIG. 1B is ³¹P NMR test spectrogram of the water-retaining material; FIG. 1C is a ¹⁵N NMR test spectrogram of the water-retaining material, and FIG. 1D is the functional group corresponding to each signal peak in the spectrogram. According to FIGS. 1A-1D, it can be seen that the carboxyl in the proton carrier compound reacts with the hydroxyl and amino in the chitosan to form the ester group and the amide group, in this way, the proton carrier compound is grafted on the chitosan. The carboxyl in the proton carrier compound of Example A1 has higher reactivity, and it is the carboxyl that has mainly been esterified and the amidized.

### 3.2 Related Characterization of Water-Retaining Proton Exchange Membrane

The membrane Y was scanned under an electron microscope, and the results are shown in FIG. 2. It can be seen that a surface of the membrane Y prepared by the preparation method in Example B2 is smooth and has no obvious defects.

### 4. Performance Test of Proton Exchange Membrane

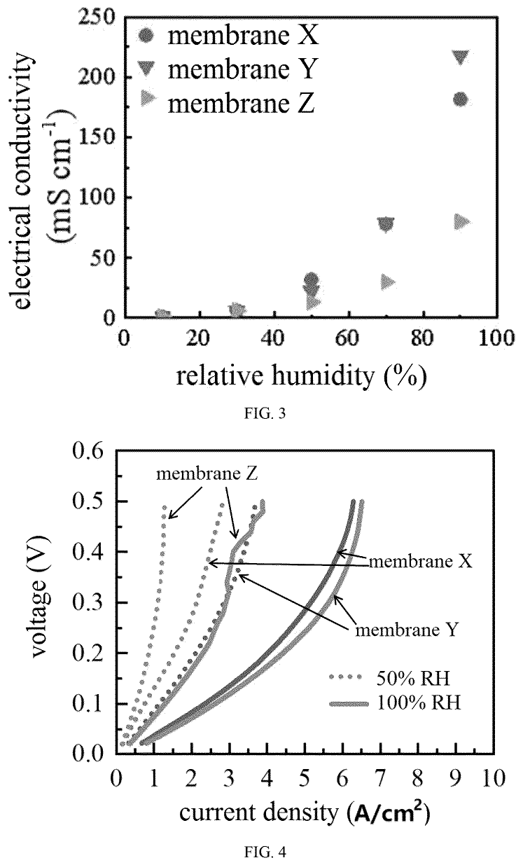

4.1 The electrical conductivities of three proton exchange membranes were tested under different relative humidities, results are shown in FIG. 3. According to FIG. 3, it can be seen that under full humidity, the electrical conductivity of membrane X and membrane Y is higher than that of membrane Z, especially at 100% relative humidity, the electrical conductivity of membrane Y is the highest. As the electrical conductivity can reflect the internal conductivity of the membrane to a certain extent, it is proved that the membrane X and membrane Y have higher moisture distribution and lower resistance, which can improve the proton conductivity in application theoretically. Therefore, doping the water-retaining material according to embodiments of the present application into the proton exchange membrane can increase the electrical conductivity of the proton exchange membrane, and when the doping amount of the water-retaining material is a gradient distribution, the electrical conductivity can be further improved.

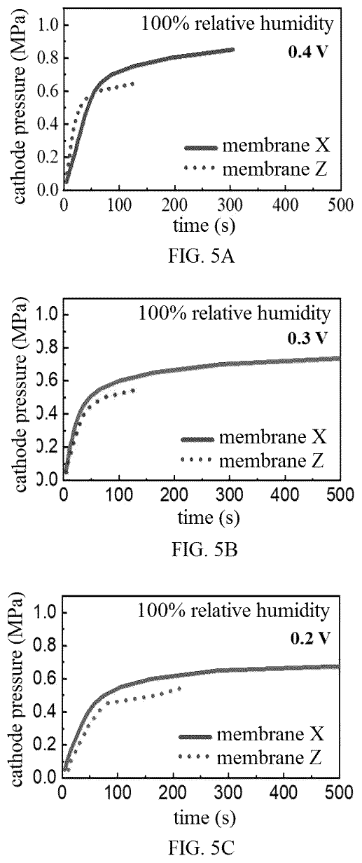

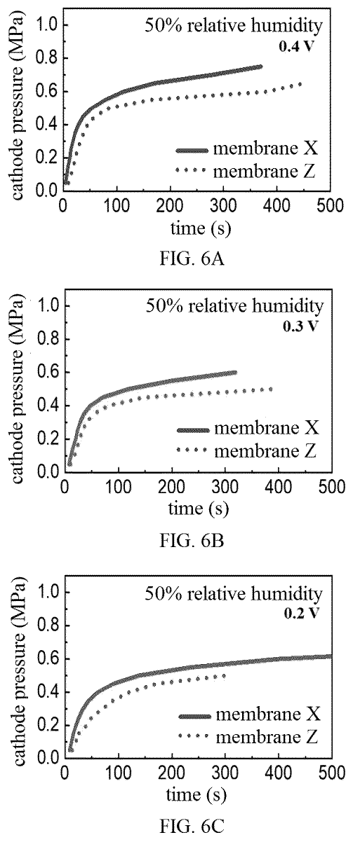

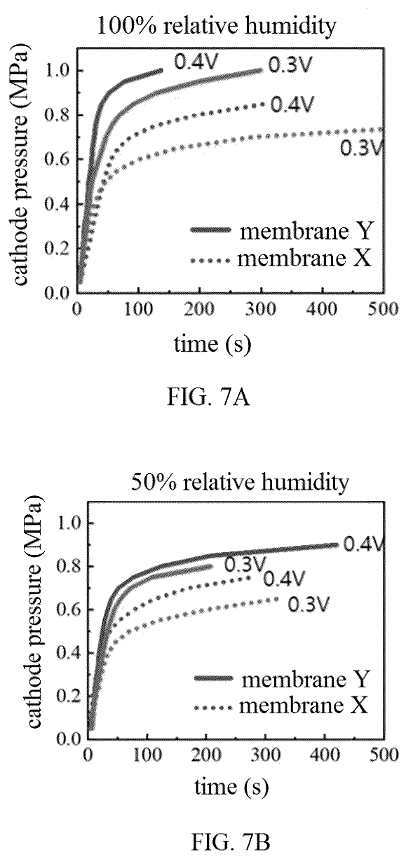

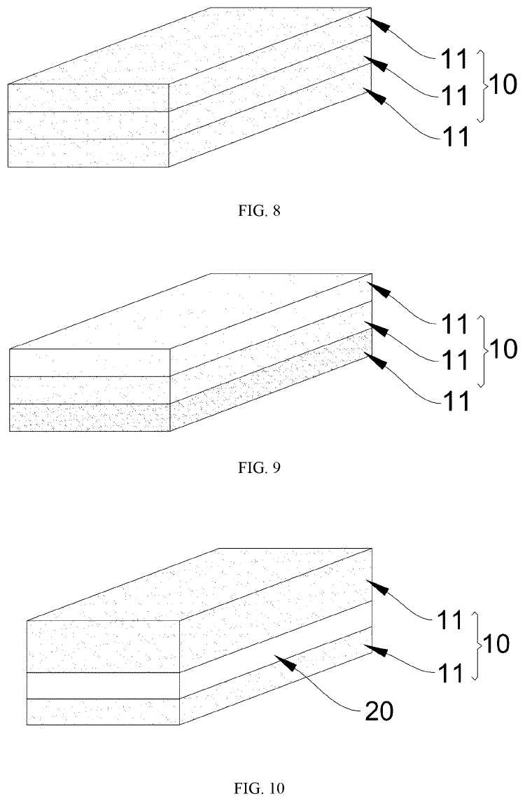

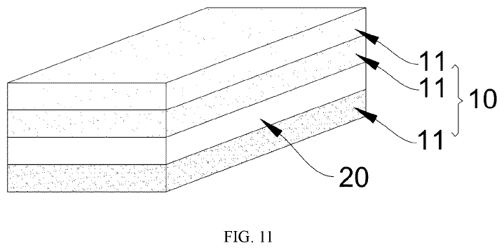

4.2 Under the relative humidity of 50% and 100%, the current densities of three proton exchange membranes were tested under different voltages, and results are shown in FIG. 4, it can be seen in FIG. 4 that in the test under the relative humidity of 50% and 100%, in condition of the same voltage, the current densities of the membrane X and the membrane Y are lower than that of the membrane Z. Therefore, the electron transport rate of the water-retaining proton exchange membrane in this example is higher, and theoretically, the proton conductivity can be improved in application.

### 4.3 Application and Performance Results of the Proton Exchange Membrane in Electrochemical Hydrogen Compressor

Three electrochemical hydrogen compressors were provided, with each electrochemical hydrogen compressor including: an anode, a cathode, and a membrane electrode. The membrane electrode is arranged between the anode and the cathode. The membrane electrode includes: a proton exchange membrane, a catalyst layer, and a gas diffusion layer. The catalyst layers are arranged at two opposite surfaces of the proton exchange membrane. Each of the gas diffusion layers is arranged on a surface of one of the catalyst layers away from the proton exchange membrane.

The difference is that the proton exchange membranes in the three hydrogen compressors are the membrane X, the membrane Y, and the membrane Z, respectively. In the membrane Y, a side having a high doping amount of the water-retaining material is close to the anode.

Three proton exchange membranes were placed in the environment having a relative humidity of 100%, the electrochemical hydrogen compressors were then operated with an operating voltage of 0.4 V, the pressure of the compressed hydrogen obtained at the cathodes of the three hydrogen compressors and the corresponding time were recorded. The devices were reset to operate at the voltage of 0.3 V, the tests were repeated and results were recorded. Thereafter, the devices were reset again to operate at the voltage of 0.2 V, the tests were repeated and results were recorded, as shown in FIG. 5, as well as FIG. 7A.

Thereafter, three proton exchange membranes were placed in an environment having a relative humidity of 50%, the above tests at operating voltages of 0.4 V, 0.3 V and 0.2 V were repeated, and the results were shown in FIG. 6, as well as FIG. 7B;

According to FIGS. 5A-5C and FIGS. 6A-6C, it can be seen that in the environments having relative humidities of 100% and 50%, compared with the membrane Z of the prior art, the hydrogen compression efficiency of the hydrogen compressor including the membrane X made of the water-retaining material is improved.

According to FIGS. 7A-7B, it can be seen that in the environments having the relative humidities of 100% and 50%, compared with the membrane X having a uniform doping amount of the water-retaining material, the doping amount of the water-retaining material of the membrane Y is a gradient distribution. In use, a side of the membrane Y having a higher doping amount of the water-retaining material is arranged close to the anode, and the hydrogen compression efficiency of the hydrogen compressor is also higher than that of the hydrogen compressor adopting the membrane X. Especially, excellent compression performance was obtained at a voltage of 0.4 V, H₂ is compressed to 0.9 MPa within 419 s at the 50% relative humidity and compressed to 1.0 MPa within 137 s at the 100% relative humidity.

Therefore, the water-retaining proton exchange membrane prepared by doping with the water-retaining material in embodiments of the present application inhibits the electroosmotic drag phenomenon in application, relieves the drying up of the anode side, and improves the proton conductivity, especially, the improvements are more obvious in condition of a gradient distribution of the doping amount. The obtained electrochemical hydrogen compressor has improved compression efficiency and improved durability.

The above descriptions are only preferred embodiments of the application, and are not intended to limit the application. Any modifications, equivalent replacements, and improvements made within the spirit and principles of the application should be included within the protection range of the application.

1. A water-retaining material, comprising:
a polymer chain segment provided by a hydrophilic polymer; and
a proton carrier group grafted to the polymer chain segment;
wherein the polymer chain segment contains a hydrophilic group.

2. The water-retaining material according to claim 1, wherein
the hydraulic group comprises at least one of a hydroxyl, an amino, an aldehyde, and a carboxyl; and/or
the proton carrier group comprises at least one of a photographic acid group, a carboxylic acid group, a sulfonic acid group, and a phenolic hydroxyl group; and/or
the proton carrier group is provided by at least one of 2-phosphonobutane-1,2,4-tricarboxylic acid, diethylphosphonoacetic acid, 4-aminobutyl phosphonic acid, and 4-phosphobutyric acid.

3. The water-retaining material according to claim 1, wherein the proton carrier group is grafted to the polymer chain segment via at least one of an ester group, an amide group, and an acid anhydride.

4. The water-retaining material according to claim 1, wherein the hydrophilic polymer comprises at least one of a chitosan, a chitosan derivative, a polyacrylic acid, and a hydrophilic polyamine.

5. A method for preparing a water-retaining material, comprising:
performing, in a reaction system comprising an activator and a catalyst, a grafting reaction between a hydrophilic polymer and a proton carrier compound to yield the water-retaining material;
wherein
the water-retaining material contains a polymer chain segment containing a hydrophilic group.

6. The method according to claim 5, wherein
the hydrophilic polymer and the proton carrier compound are mixed according to a molar ratio of between 5:1 and 1:20; and/or
the hydrophilic polymer comprises at least one of a chitosan, a chitosan derivative, a polyacrylic acid, a hydrophilic polyamine; and/or
the proton carrier compound comprises at least one of 2-phosphonobutane-1,2,4-tricarboxylic acid, diethylphosphonoacetic acid, 4-aminobutyl phosphonic acid, and 4-phosphobutyric acid.

7. The method according to claim 5, wherein the grafting reaction comprises at least one of an esterification reaction, an amidation reaction, and an anhydride formation reaction.

8. The method according to claim 5, wherein
the reaction system comprises a solvent, and the solvent comprises at least one of dimethyl sulfoxide, N,N-dimethylformamide, tetrahydrofuran, and N-methylpyrrolidone; and/or
the catalyst comprises at least one of 4-dimethylaminopyridine, 4-pyrrolidinylpyridine, and 9-azajulolidine; and/or
the activator comprises at least one of N,N′-dicyclohexylcarbodiimide, N-hydroxysulfosuccinimide, carbodiimide, and N,N′-diisopropylcarbodiimide.

9. The method according to claim 5, after the grafting reaction, further comprising a step of purifying the water-retaining material, the step of purifying the water-retaining material comprising:
washing, extracting, and dialyzing the water-retaining material.

10. A water-retaining proton exchange membrane, comprising a matrix;
wherein
the matrix is doped with a water-retaining material; and
the water-retaining material comprising the water-retaining material according to claim 1.

11. The water-retaining proton exchange membrane according to claim 10, wherein
a material of the matrix comprises at least one of a perfluorosulfonic acid resin, a polyether ether ketone, a polybenzimidazole, a polyethersulfone polysulfone, and a polyimide.

12. The water-retaining proton exchange membrane according to claim 10, wherein the water-retaining material accounts for between 0.1 wt. % and 50 wt. % of a total weight of the matrix and the water-retaining material.

13. The water-retaining proton exchange membrane according to claim 10, wherein
a doping amount of the water-retaining material in the matrix presents a gradient distribution from a surface of the matrix to another opposite surface of the matrix.

14. The water-retaining proton exchange membrane according to claim 10, wherein
the matrix comprises at least two base films,
the doping amount of the water-retaining material in each of the at least two base films is different; and
in a direction from a surface of the matrix to another opposite surface, the at least two base films are stacked such that the water-retaining material presents a gradient distribution.

15. The water-retaining proton exchange membrane according to claim 14, wherein a single base film has a thickness of between 1 μm and 50 μm.

16. The water-retaining proton exchange membrane according to claim 14, further comprising a reinforcing layer, wherein the reinforcing layer is stacked between any two adjacent base films.

17. The water-retaining proton exchange membrane according to claim 16, wherein a material of the reinforcing layer comprises at least one of an expanded polytetrafluoroethylene, a polyether ether ketone, and a carbon nanotube.

18. The water-retaining proton exchange membrane according to claim 16, wherein the reinforcing layer has a thickness of between 1 μm and 20 μm.

19.-24. (canceled)

25. The water-retaining material according to claim 2, wherein the proton carrier group is grafted to the polymer chain segment via at least one of an ester group, an amide group, and an acid anhydride.

26. The water-retaining material according to claim 2, wherein the hydrophilic polymer comprises at least one of a chitosan, a chitosan derivative, a polyacrylic acid, and a hydrophilic polyamine.
